(19) United States
(12) Patent Application Publication
(10) Pub. No.: US 2004/0061938 A1
(43) Pub. Date: Apr. 1, 2004

(54) Process / single component for providing dual functions-light polarization and color filtering

(75) Inventors: Wen-Chin Lo, Jubei City (TW); Dao-Yang Huang, Hsinchu (TW); Hung-Hsiang Liu, Miaoli City (TW)

Correspondence Address: KLARQUIST SPARKMAN, LLP, 121 SW SALMON STREET, SUITE 1600, PORTLAND, OR, 97204, US

(73) Assignee: Cando Corporation

(21) Appl. No.: 10/256,430

(22) Filed: Sep. 26, 2002

(51) Int. Cl. G02B 5/30

(52) U.S. Cl. 359/502; 359/483; 359/891

(57) ABSTRACT

The present invention relates to a single component performing light polarization and color filtering, and to a production process making the component. The component comprises a polarization plate with photo resistant material of three primary colors distributed at a plurality of dot locations on one of its surface, and with light absorbing material disposed between any adjacent two of the dot locations. The production process comprises the steps of forming a dot matrix on a surface of the polarization plate and filling photo resistant material onto the dots of the dot matrix.

### FIELD OF THE INVENTION

The present invention generally relates to a component performing light polarization and color filtering, and particularly to a production process making a component capable of performing both light polarization and color filtering.

### BACKGROUND OF THE INVENTION

Conventionally, no matter what (a device, apparatus, system, or an operation) is concerned, whenever there are needs for light polarization and color filtering, polarizer and color filter must respectively be prepared and then properly integrated. If a single component is available for providing both functions of light polarization and color filtering, the processes of material acquisition and storage as well as component integration and product manufacturing can be significantly simplified, both the cost and man-power associated with the production can be minimized, and the size of product so manufactured can be reduced, obviously resulting in superiority to what is conventionally available for related industries.

FIG. 1 is a perspective view showing the structure of a conventional TFT-LCD (thin film transistor liquid crystal display) comprising a polarizer and a color filter, wherein the polarizer 1 and color filter 11 must be respectively prepared before being integrated properly with a glass plate 6 therebetween. If a single component 33 as shown in FIG. 2 is available for providing both functions of light polarization and color filtering, the processes of acquisition, storage, installation, and test for polarizer 1 shown in FIG. 1 and for color filter 11 also shown in FIG. 1 can be simplified to the extent that they are necessary only for one component instead of two.

A conventional basic process for making a color filter comprises the following steps: forming on a surface of a glass substrate a layer of BM(Black Matrix) capable of blocking light (or absorbing light); then evenly and respectively distributing, on the exposed portion of the surface of the glass substrate, three different photo resistant layers each in one of three primary colors (Red, Green, and Blue); and finally plating (by vacuum sputtering) to form ITO. A color filter made on the basis of such a conventional process provides only one function-color filtering, and has to be integrated with a plarizer to provide functions including polarization and color filtering. It is impossible to achieve the functions including polarization and color filtering by such a conventional process.

Another inferiority or weakness of the aforementioned conventional process for making a color filter is that the glass substrate used therein is relatively fragile, resulting in many restrictions it must be subjected to and a bottle-neck it must face in improving failure rate.

If the glass substrate used in the aforementioned conventional process of making a color filter is substituted by a polarizing plate (or called “polarizer”), not only will the single production process be able to make a single component capable of performing functions including polarization and color filtering, but it will also result in significant improvement of production failure rate and lead to significant reduction of product cost, because the polarizing plate is the type of material of competitive cost, high tenacity, and better shock resistance for protection from cracking during production process, as well as optimum adaptability to display applications of larger size. This is why the present invention has been developed to realize a single component capable of providing functions including polarization and color filtering, with the single component manufactured by a production process more economical, more reliable, and less restricted than the one manufacturing a conventional color filter which provides only one function-color filtering. This is obvious because the present invention leads to effective improvement of production failure rate, significant lessening of production environment limitation and allocation restriction, as well as great reduction of production time, resulting in lower manufacturing cost, higher production reliability, and better adaptability to production environment and allocation. Furthermore, the art provided by the present invention for realizing such a single component capable of providing functions including polarization and color filtering, will enable related industries to dynamically and flexibly adapt to various application demands such as providing products in swift response to clients' order for specifications of various sizes.

### SUMMARY OF THE INVENTION

A first object of the present invention is to provide a single component capable of performing functions including polarization and color filtering.

A second object of the present invention is to provide a production process for making a single component capable of performing functions including polarization and color filtering.

A third object of the present invention is to simplify the production process for making a component providing functions including polarization and color filtering.

A fourth object of the present invention is to provide a production process consuming less time for making a component providing functions including polarization and color filtering.

A fifth object of the present invention is to lower the cost of making a component capable of performing functions including polarization and color filtering.

A sixth object of the present invention is to enable related industries to dynamically and flexibly adapt to various application demands such as providing products in swift response to clients' order for specifications of various sizes.

A seventh object of the present invention is to reduce the size of an entire product including components performing polarization and color filtering.

The component developed according to the present invention for performing functions including polarization and color filtering is characterized by comprising: a polarization plate for polarizing light, the polarization plate including a surface having a plurality of dot locations thereon; photo resistant material of three types each in a different one of three primary colors (in other words, each type in one primary color and different from another type in color, e.g., three types respectively in red color, green color, and blue color), and disposed at different ones of the dot locations (i.e., different types respectively disposed at a different plurality of ones of the dot locations), the photo resistant material at any adjacent two of the dot locations being different; and light absorbing material disposed between adjacent two of the dot locations, the light absorbing material for absorbing at least part of light applied thereto.

In the component developed according to the present invention for performing functions including polarization and color filtering, the more evenly the photo resistant material is disposed, the better the component may perform the functions. The photo resistant material at adjacent two of the dot locations are different, i.e., are respectively in two of three primary colors, such as one in red color and another in green or blue color. The photo resistant material of each type had better disperse evenly. The light absorbing material disposed between any adjacent two of the dot locations had better also disperse evenly. There is a practical embodiment: the dot locations are arranged in the form of a matrix, with adjacent two of the dot locations separated by the light absorbing material.

A process developed according to the present invention for making a single component capable of performing polarization and color filtering, comprises the steps of forming a dot matrix on a surface of a polarization plate and filling photo resistant material onto the dots of the dot matrix. The step of forming the dot matrix on the surface is such that each dot of the dot matrix exposes a point of the surface, and adjacent dots of the dot matrix are separated by light absorbing material. The step of filling photo resistant material onto the dots of the dot matrix is such that the photo resistant material at each dot of the dot matrix is in one primary color and the photo resistant material at any adjacent dots of the dot matrix are different in color. For example, if the photo resistant material at an arbitrary dot of the dot matrix is in red color, the photo resistant material at one dot of the dot matrix which is adjacent to the arbitrary dot shall be in green color or blue color.

The present invention may best be understood through the following description with reference to the accompanying drawings, in which:

### BRIEF DESCRIPTION OF THE DRAWINGS

FIG. 1 shows a schematic view of a cross section of a conventional TFT-LCD made of components including a polarizer and a color filter respectively prepared.

FIG. 2 shows a schematic view of a cross section of a conventional TFT-LCD made of components among which a single component provided by the present invention, instead of two conventional components, is used to perform polarization and color filtering.

FIGS. 3-6 show an example of embodying the process for making a single component provided by the present invention to perform functions including both polarization and color filtering.

FIG. 7 shows a cross sectional view of an embodiment of a single component provided by the present invention to perform functions including both polarization and color filtering, and serves as reference for illustrating FIGS. 3-6.

FIG. 8 shows a top view of an embodiment of a single component provided by the present invention to perform functions including both polarization and color filtering, and serves as reference for illustrating the process of such a single component.

### DETAILED DESCRIPTION OF THE PREFERRED EMBODIMENTS

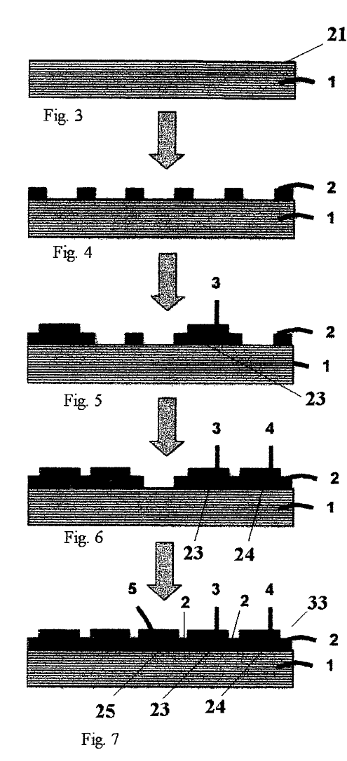

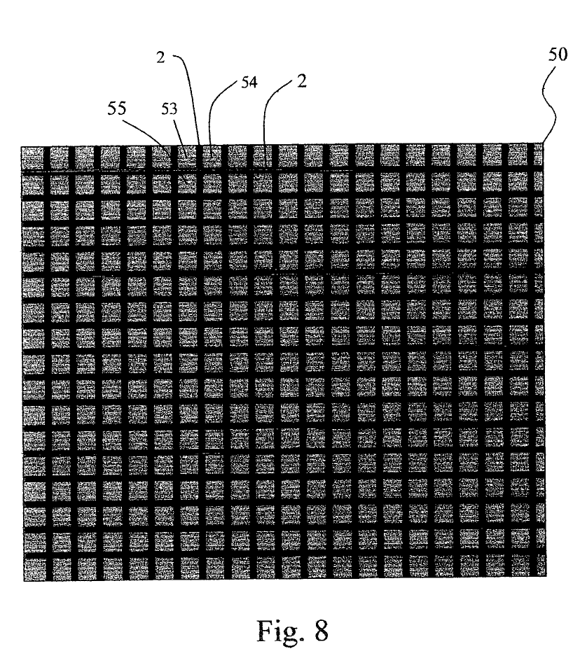

A preferred embodiment of a single component provided by the present invention to perform functions including both polarization and color filtering, is here described with reference to FIG. 7 (cross sectional view) and FIG. 8 (top view). The single component 33 provided by the present invention to perform the functions, comprises: a polarization plate 1 including a surface 21 (as shown in FIG. 3) having a plurality of dot locations thereon such as 23, 24, and 25; photo resistant material of three types each in a different one of three primary colors and disposed at a different plurality of ones of the dot locations, such as red one 3 at dot locations represented by 23, green one 4 at dot locations represented by 24, and blue one 5 at dot locations represented by 25; and light absorbing material 2 disposed between any adjacent two of the dot locations (e.g., light absorbing material 2 disposed on the area between dot locations 23 and 25, and on the area between dot locations 23 and 24). The photo resistant material at any adjacent two of the dot locations are different, i.e., if the photo resistant material at dot location 23 is red color, the photo resistant material at its adjacent dot locations such as 24 and 25 are in colors different from red one, as shown in FIG. 7 where red photo resistant material 3 is at dot location 23, green photo resistant material 4 at dot location 24, and blue photo resistant material 5 at dot location 25. Each type of the photo resistant material, such as the red one represented by 3 in FIG. 7, or the green one represented by 4 in FIG. 7, or the blue one represented by 5 in FIG. 7, had better be disposed evenly over the surface 21 (shown in FIG. 3). The more evenly the three types of photo resistant material are disposed over the surface 21, the better the product may perform its functions. Light absorbing material 2 is for absorbing at least part of light applied thereto, and may also be disposed around each of the dot locations, i.e., the photo resistant material (different colors) at any adjacent two of the dot locations are separated from each other by light absorbing material 2. Similarly the way to dispose the light absorbing material 2 is that the more evenly the light absorbing material 2 is disposed over surface 21 the better the product may be. A feasible embodiment according to the present invention: the dot locations such as 23, 24, and 25 on polarization plate I in FIG. 7 form a matrix 50 with top view shown in FIG. 8 where 53 and 54 represent two adjacent dot locations with light absorbing material 2 therebetween, and 53 and 55 also represent two adjacent dot locations with light absorbing material 2 therebetween. If the photo resistant material at the dot locations represented by 53 is in a first primary color, those at the dot locations represented by 54 and 55 (i.e., those adjacent to the ones represented by 53) are in second or third primary color. The dot location is not necessarily a square, and may be of any shape. The only important aspect regarding the dot locations is that the more evenly they are distributed, the better the product may be.

A preferred embodiment of the process provided by the present invention to make such a single component capable of performing functions including both polarization and color filtering, is here described with reference to FIG. 3 and FIG. 8. The process comprises the steps of forming a dot matrix 50 (as shown in FIG. 8) on the surface 21 (FIG. 3) and filling photo resistant material onto the dots (such as 53, 54, and 55) of the dot matrix 50. The step of forming dot matrix 50 on the surface 21 is such that each dot of the dot matrix 50 exposes a point of the surface 21, and adjacent dots of the dot matrix 50 are separated by light absorbing material 2. The step of filling photo resistant material 2 onto the dots of the dot matrix 50 is such that the photo resistant material 2 at each dot of the dot matrix 50 is in one primary color and the photo resistant material at any adjacent dots of the dot matrix are different in color. For example, if the photo resistant material at an arbitrary dot 53 of the dot matrix 50 is in red color, the photo resistant material at one dot (such as 54 or 55) of the dot matrix 50 which is adjacent to the arbitrary dot 53 shall be in green color or blue color.

The step of filling photo resistant material onto the dots of the dot matrix 50 may also be described as follows. Part 2 in FIG. 4 is light absorbing material 2 shown in dot matrix 50 of FIG. 8, part 3 in FIG. 5 represents photo resistant material of first primary color filled onto dot location 23 (shown in FIG. 5) of a dot matrix 50 such as the one shown in FIG. 8, part 4 in FIG. 6 represents photo resistant material of second primary color filled onto dot location 24 (shown in FIG. 6) of the dot matrix 50, and part 5 in FIG. 7 represents photo resistant material of third primary color filled onto dot location 25 (shown in FIG. 7) of the dot matrix 50. FIG. 7 shows a cross sectional view of a single component which is made according to the preferred process provided by the present invention and which is capable of performing functions including both polarization and color filtering.

The light absorbing material 2 according to the present invention may be in black color with capability of blocking light, or may be material with capability of anti-reflection. The photo resistant material such as those represented by 3, 4, and 5 in FIG. 7 are material allowing only the light of a specific color to propagate therethrough. For example, the photo resistant material respectively in three primary colors such as red, green, and blue, respectively allow only the light of red, green, and blue colors to propagate therethrough.

The matrix 50 according to the present invention is designed on the basis of the expected specification of the single component, such as the resolution or size thereof. The dot matrix 50 (shown in FIG. 8) in the process according to the present invention may be formed by means such as pigment-distribution, or ink-jetting, or hot-image-transferring, or printing, or the combination thereof. The step of filling photo resistant material (such as 3, 4, and 5 shown in FIG. 7) onto the dots (such as 23, 24, and 25 shown in FIG. 7) of the dot matrix 50 may also be performed by at least a means selected from among pigment-distribution, ink-jetting, hot-image-transferring, and printing.

The process provided by the present invention for making such a single component capable of performing functions including both polarization and color filtering, may further comprises a step of covering the light absorbing material 2 (shown in FIGS. 7 and 8) and the photo resistant material (such as 3, 4, and 5 shown in FIG. 7) by a protection layer 15 (shown in FIG. 2), after the step of forming dot matrix 50 (as shown in FIG. 8) on the surface 21 (shown in FIG. 3) and the step of filling photo resistant material 2 onto the dots of the dot matrix 50. The protection layer 15 may further cover the part of surface 21 (shown in FIG. 3) which has not been covered by the light absorbing material 2 and the photo resistant material 3, 4, and 5 all as shown in FIG. 7, after the step of forming dot matrix 50 on the surface 21 and the step of filling photo resistant material 2 onto the dots of the dot matrix 50.

The dots of dot matrix 50 according to the process provided by the present invention are not necessarily located in straight lines, all the dots adjacent to an arbitrary dot are not necessarily symmetrically located relative to the arbitrary dot, and the shape and size of all dots are not necessarily consistent. What is important is that the more evenly the photo resistant material or the light absorbing material is disposed, the better the product may be.

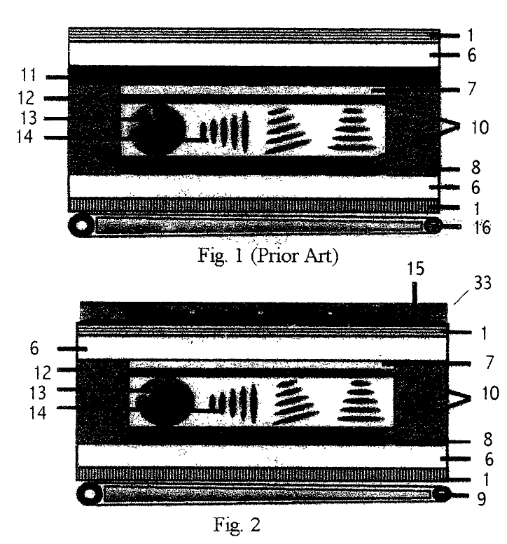

In FIGS. 1 and 2, numerical references 7-14, and 16 are used to represent the existence of another components of a TFT-LCD.

While the invention has been described in terms of what are presently considered to be the most practical or preferred embodiments, it shall be understood that the invention is not limited to the disclosed embodiment. The spirit and scope of the invention shall cover any modifications or similar arrangements.

What is claimed is:

1. A component for performing polarization and color filtering, comprising:
a polarization plate for polarizing light, said polarization plate including a surface having a plurality of dot locations thereon;
photo resistant material of three types each in a different primary color and disposed at different ones of said dot locations, the photo resistant material at any adjacent two of said dot locations being different in color; and
light absorbing material disposed between any adjacent two of said dot locations for absorbing at least part of light.

2. The component according to claim 1 wherein the photo resistant material of said three types are evenly disposed.

3. The component according to claim 1 further comprising a protection layer covering said photo resistant material and said light absorbing material.

4. A process for making a single component capable of performing polarization and color filtering, comprising the steps of:
forming a dot matrix on a surface of a polarization plate, each dot of said dot matrix exposing a point of said surface, adjacent two dots of said dot matrix being separated by light absorbing material; and
filling photo resistant material onto the dots of said dot matrix in such a way that the photo resistant material at each dot of said dot matrix is in one primary color and the photo resistant material at any adjacent dots of said dot matrix are different in color.

5. The process according to claim 4 wherein said light absorbing material is in black color for absorbing at least part of light applied thereto.

6. The process according to claim 4 wherein said primary colors are red color, green color, and blue color, and the photo resistant material in different said primary colors are respectively disposed evenly.

7. The process according to claim 4 further comprising a step of covering said light absorbing material and said photo resistant material by a protection layer.

8. The process according to claim 4 wherein the step of forming said dot matrix is by at least one means selected from among pigment-distribution, ink-jetting, hot-image-transferring, and printing.

9. The process according to claim 4 wherein the step of filling the dots of said dot matrix with said photo resistant material is by at least one means selected from among pigment-distribution, ink-jetting, hot-image-transferring, and printing.
